(19) United States
(12) Patent Application Publication
(10) Pub. No.: US 2018/0355974 A1
(43) Pub. Date: Dec. 13, 2018

(54) GASKET STRUCTURE AND METHOD OF FABRICATION

(71) Applicant: OG Supply, LLC, Cibolo, TX (US)

(72) Inventors: Robert Muir, New Braunfels, TX (US); Richard Cowen, Huffman, TX (US)

(21) Appl. No.: 15/617,273

(22) Filed: Jun. 8, 2017

(51) Int. Cl. F16J 15/10

(52) U.S. Cl. CPC F16J 15/104; F16J 15/102; F16J 15/108

(57) ABSTRACT

A tadpole-type gasket and a method of fabrication. The gasket includes a core and a jacket. One embodiment of the jacket includes a woven fabric strip in which the warp threads are omitted from the strip in two separated portions to form first and second longitudinally extending drop warp portions with weft yarns joining completely woven portions on either side. The strip is wrapped about the core so that the drop warp portions overlie each other, and completely woven portions of the strip overly each other. Portions of the completely woven portions are secured together. The weft yarns in the overlying drop warp portions are readily separated to push a fastener therethrough. In another embodiment, the jacket includes slitted portions which overlie each other, which are readily separated by a fastener.

### BACKGROUND

Gaskets are commonly used for sealing in various applications including ovens, duct work, boiler doors, to name just a few. One common type is known as a “tadpole” gasket, because the gasket in cross-section has a tadpole-like shape, in which a core is wrapped with a tape, and the tail is used to secure the gasket in place. Typically, the gasket may be fabricated with a hole pattern along the tail section to provide for fasteners to be passed through. This increases the cost, and limits the versatility of the gasket to applications for which the hole pattern is designed.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic top isometric view of an exemplary embodiment of a gasket structure.

FIG. 2 is a diagrammatic top view of an exemplary embodiment of the double drop warp fabric from which the jacket for the gasket structure of FIG. 1 is fabricated.

FIG. 3 is an perspective view of a section of an exemplary embodiment of a gasket structure.

FIG. 4 is a simplified schematic illustration of the gasket structure of FIG. 3 in partially exploded end view.

FIG. 5 is a plan view of a portion of an exemplary embodiment of woven material from which the gasket structure is fabricated.

FIG. 6 is a top view of a portion of the gasket structure of FIG. 3, illustrating how the weft yarns in the drop warp portion are easily manipulated to form an opening for a fastener.

FIG. 7 is a view of the gasket structure of FIG. 3, illustrating fasteners passed through the drop warp portion of the tail portion of the gasket structure.

FIG. 8 is a diagrammatic top view of an alternate embodiment of a gasket structure.

FIG. 9 is a plan view of a portion of an exemplary embodiment of material from which the gasket structure of FIG. 8 is fabricated.

### DETAILED DESCRIPTION

In the following detailed description and in the several figures of the drawing, like elements are identified with like reference numerals. The figures may not be to scale, and relative feature sizes may be exaggerated for illustrative purposes.

An exemplary embodiment of a tadpole-type gasket structure 50 is illustrated in diagrammatic form. The gasket structure includes a woven fabric jacket 70 enveloping the gasket core 60, and forming the gasket bulb portion 80 and tail portion 78.

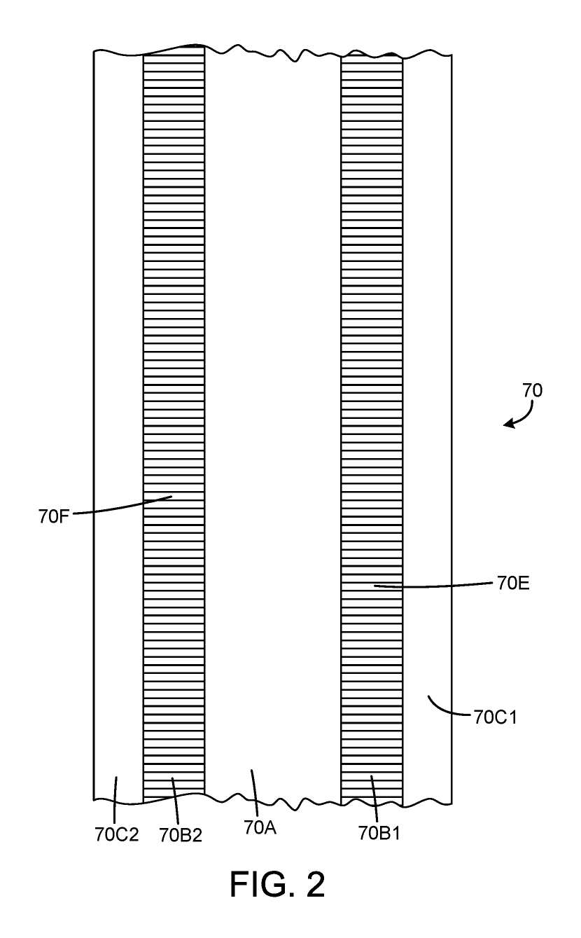

The jacket 70 is shown in pre-assembly form in FIG. 2. The jacket is formed from an elongated strip, which includes fully woven portions 70A, 70 C1 and 70 C2. The completely woven longitudinal portions are separated by respective “drop warp” longitudinal portions 70 B1 and 70 B2. In these drop warp portions, the warp yarns are omitted, creating longitudinal gaps, so that portions 70A and 70C1 are connected only by weft yarns 70E, and portions 70A and 70 are also connected only by the weft yarns 70E

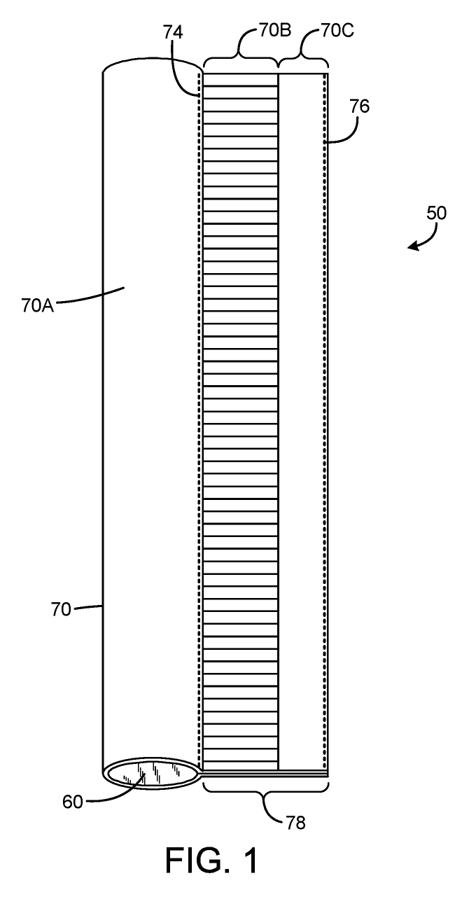

To assembly the gasket structure, the core 60 is positioned on completely woven portion 70A, and portions 70 B2 and 70 C2 are wrapped over the core to overly respective portions 70 B1 and 70 C1. The overlapped fabric portions are then stitched together to form seals 74 and 76 (FIG. 1. Seam 74 secures the core in place within the jacket, and seam 76 secures together the overlying completely woven portions 70 C1 and 70 C2

The weft yarns in the overlying drop warp portions, shown as portion 70 B in FIG. 1, are easily separated to form openings in these portions, to receive fasteners, thus eliminating the need for a separate operation to cut or form holes in the tail portion 78.

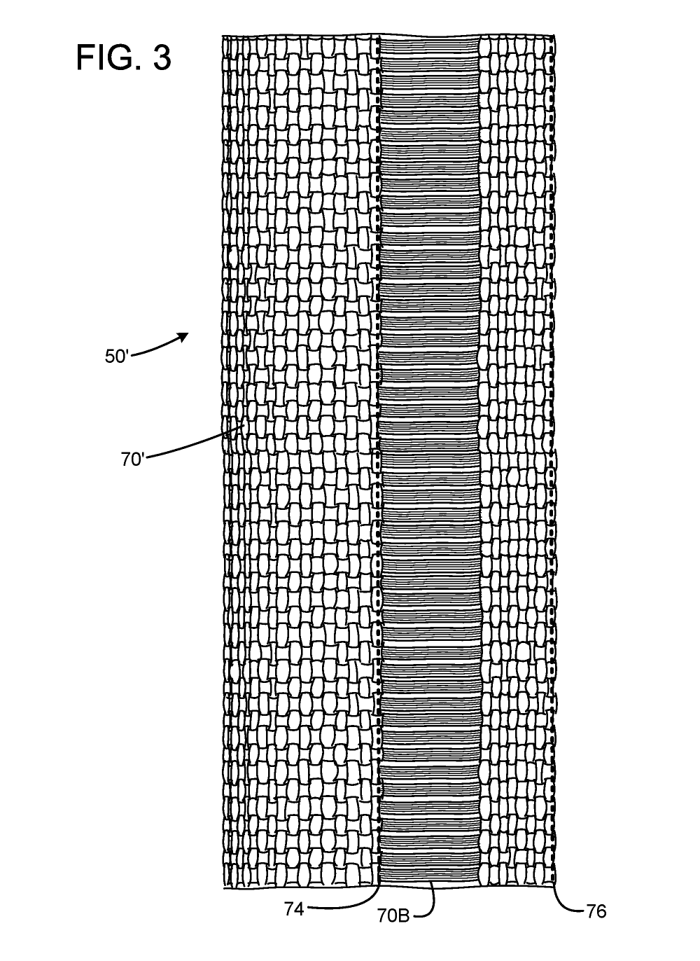

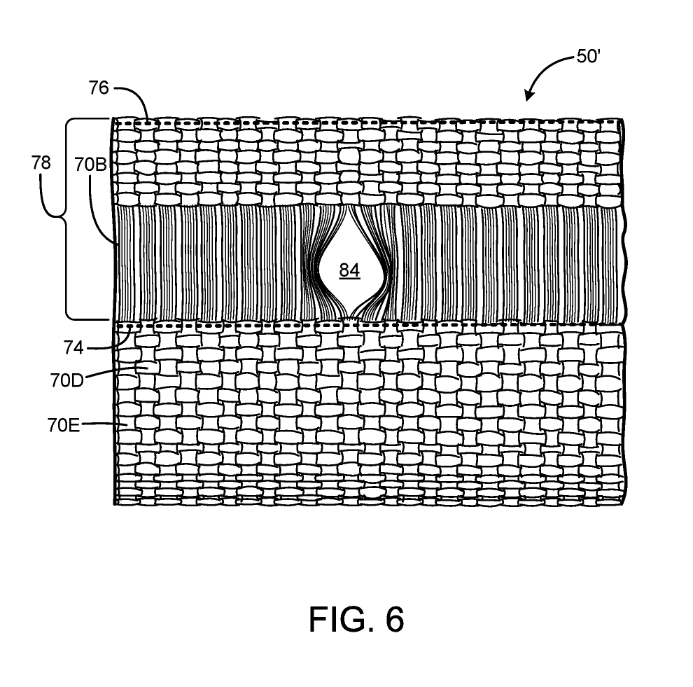

Features of a further exemplary embodiment of a gasket structure 50′ is shown in FIGS. 3-7. The structure 50′ is shown as a fragment or portion of a gasket, whose length and other features and dimensions may be adapted to particular applications. The structure includes a core section 60, about which is wrapped a woven fabric jacket 70′, shown in detail in FIG. 5.

The core 60 is generally cylindrical in cross-section in this embodiment, although other cross-sectional configurations may be employed, such as oval, square or rectangular. The material from which the core is fabricated will vary, depending on the application. One exemplary material is braided rope of texturized fiberglass, but could be other materials, such as ceramic, carbon, graphite, aramid, polytetrafluoroethylene with or without wire reinforcement. The size (diameter or other cross-sectional dimensions) may also be varied, and depend on the application.

The jacket 70′ is formed of woven fabric, a drop warp longitudinal strip. The fabric in one exemplary embodiment is a texturized fiberglass fabric, either plain or with a vermiculite coating. Other exemplary fabric materials include ceramic, carbon, graphite, aramid, polytetrafluoroethylene with or without wire reinforcement.

The jacket 70′ is shown prior to assembly to the core in FIG. 5. The jacket is formed from an elongated fabric strip, of which a portion is shown in FIG. 5. The strip includes three completely woven longitudinal portions, the center woven portion 70A, and outer woven portions 70 C1 and 70 C2. By “completely woven,” in this context is meant that the portions include both warp (longitudinal) yarns and weft (transverse) yarns in the weave pattern generally indicated as pattern 70D. The completely woven longitudinal portions are separated by respective “drop warp” longitudinal portions 70 B1 and 70 B2. In these drop warp portions, the warp yarns are omitted, creating longitudinal gaps, so that portions 70A and 70C1 are connected only by weft yarns 70E, and portions 70A and 70C2 are also connected only by the weft yarns 70E.

The fabric strip is flexible, to allow the core 60 to be longitudinally placed on area 70 A, and portions 70B2 and 70C2 folded over the core, so that drop warp portion 70B2 overlies drop warp portion 70B1, and completely woven portion 70C2 overlies completely woven portion 70C1. The width of the center portion 70A is at a minimum equal the circumference of the core material 60, so that a line of stitching through the doubled layers of the fabric strip can be made adjacent the core and inside the overlying drop warp portions. Similarly, the edges of the completely woven portions 70C1, 70C2, which now overlie each other, can be stitched together, to complete the jacket around the core and the tail of the gasket.

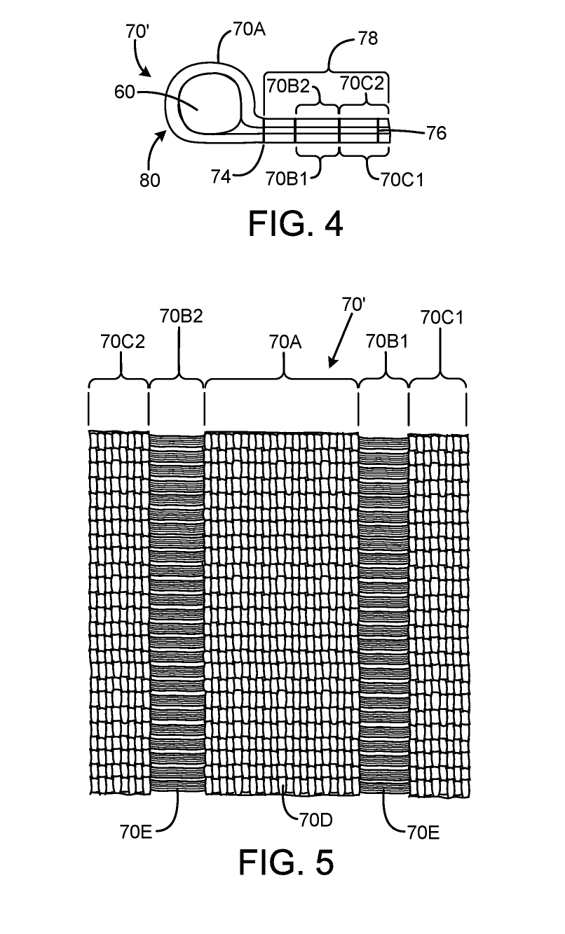

FIG. 4A schematically illustrates the construction of the gasket 50′, in which the doubled layers are shown slightly separated for clarity; once the layers are stitched together, the doubled layers will be held together. As shown, the fabric strip of the jacket is wrapped over the core 60, with portion 70A enveloping the core, with drop warp portion 70B2 overlying the drop warp portion 7061. A stitching seam 74 is positioned through the doubled fabric strip adjacent the core 60 to secure the overlapped strip portions, forming a pocket for the core, and gasket bulb 80. A second stitching seam 76 is positioned through the doubled fabric strip outside the drop warp portions to secure together the ends of the overlapped fabric portions as the tail ending, completing fabrication of the gasket tail 78. Other alternative fastening or bonding techniques could be employed to secure the overlying portions, instead of the stitching. For example, the stitching could be replaced or augmented by adhesives or tacky coated elastomeric materials.

Properties of exemplary embodiments of a woven fabric strip for the jacket 70′ in accordance with features of the invention are shown in the following table. The fabric strip may be provided in the form of a roll, of lengths shown in the table, formed of texturized fiberglass woven fabric, either plain or with a vermiculite coating. The fabric thickness and width dimensions are variable, as well as characteristics of the core, depending on the application and fabric properties. Of course, these properties are exemplary; the various properties may vary depending on the application.

Physical Properties:

| Thickness | Width | Roll length | Yarn thickness (tex) | | Yarn count(pc/cm) | | Density |
|---|---|---|---|---|---|---|---|
| (mm) | (mm) | (m) | Warp | Weft | Warp | Weft | (g/m2) |
| 1.5 | 10-200 | 30 or 50 | 1000 | 480 | 7.2 | 3.9 | 1100 |
| 2 | 10-200 | | 1720 | 480 | 5.8 | 3 | 1400 |
| 2.5 | 13-200 | | 2000 | 480 | 5.8 | 3 | 1750 |
| 3 | 13-200 | | 2700 | 1200 | 4.8 | 1.9 | 2000 |
| 6 | 20-200 | | 3600 | 1500 | 7 | 1.7 | 3800 |

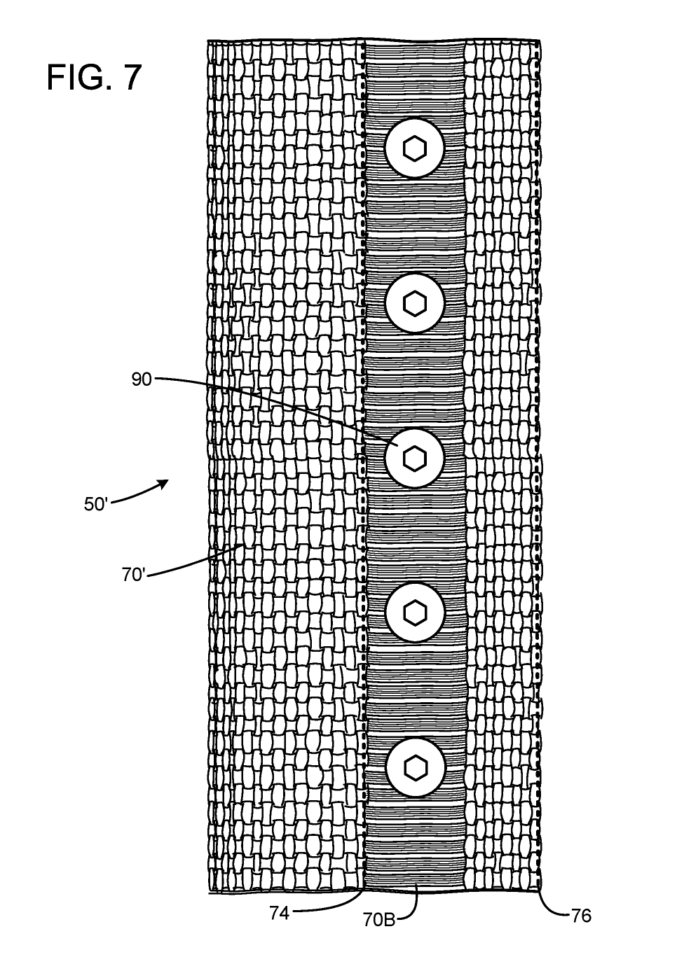

As shown in FIG. 6, the weft yarns in the drop warp portions are easily separated to form openings 84 in these portions, to receive fasteners. FIG. 7 shows an exemplary gasket section with fasteners 90 pushed through the drop warp portions. In an exemplary embodiment, the number of warp yarn strands can be 7.2 per centimeter, or 18 yarns strands per inch, The number of dropped warp yarn strands in the drop warp portions is determined by the targeted fastener (e.g. bolt) sizes.

The finished gasket product can be made from almost any weave-able material and stitched over any type of core suitable for the intended application.

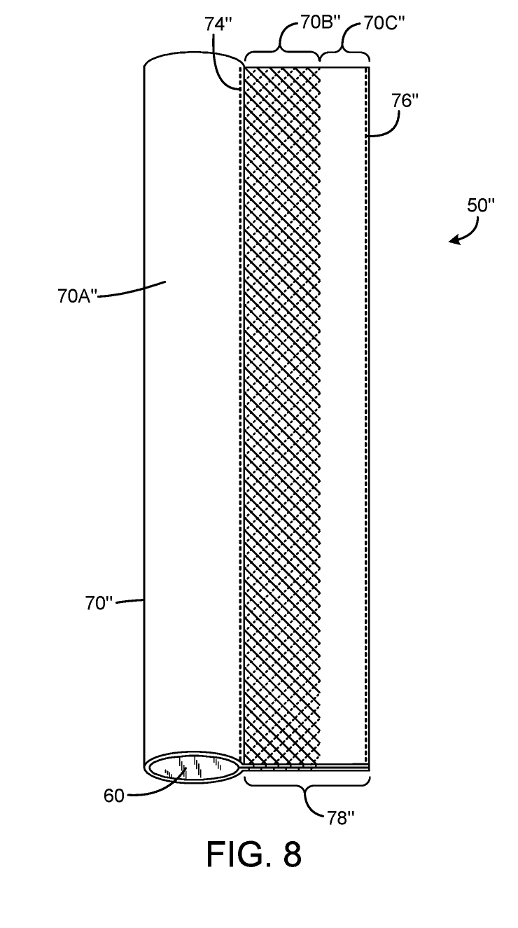

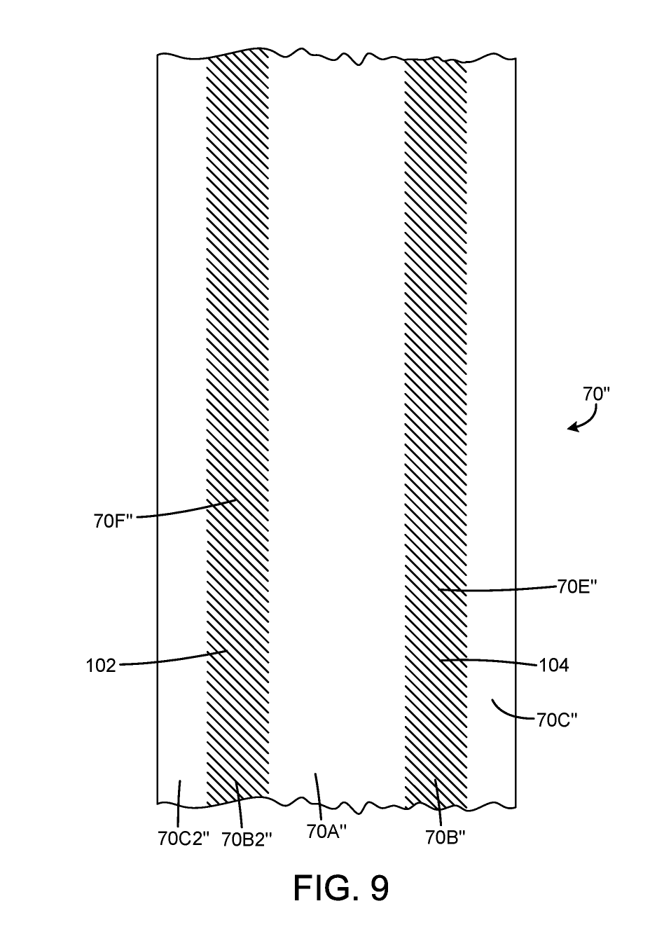

An alternate embodiment of a gasket structure 50′ is illustrated in FIGS. 8 and 9. This alternate embodiment employs a solid material layer for the jacket 70″, e.g. a rubberized tacky cloth, with knife slits, so that when the layer is folded over, the slits created an X type pattern which would also allow for fasteners to easily be pushed through.

The jacket 70″ is shown prior to assembly to the core 60 in FIG. 9. The jacket is formed from an elongated layer strip, of which a portion is shown in FIG. 9. The strip includes three longitudinal portions, the center portion 70A″, and outer portions 70 C1 “and 70 C2”. These longitudinal portions are separated by respective longitudinal slit portions 70 B1″ and 70 B2″, in which slits 102, 104 are formed in the solid material layer, e.g. by a knife or blade system. The longitudinal portions are joined by respective strip portions defined by the slits. In this embodiment, the slits are at 45 degrees from the longitudinal axis, and spaced apart by ⅛ inch. The slit portions in this example have a width of 1 inch, with center portion 70A″ having a width of 2.5 inches, and the width of the jacket layer 70″ is 5.0 inches.

As shown in FIG. 8, the jacket 70″ is folded over the core 60, so that the overlying slit portions create an “X” type pattern, which allows fasteners to be pushed through readily. The overlying solid portions can be bonded together by stitch seams 74″ and 76″, or by adhesive coating all or portions of the overlying portions.

Although the foregoing has been a description and illustration of specific embodiments of the subject matter, various modifications and changes thereto can be made by persons skilled in the art without departing from the scope and spirit of the invention.

1. A gasket structure, comprising:
a core;
a jacket wrapped about the core, comprising:
a woven fabric strip having a strip width, in which a plurality of warp threads are omitted from the strip in two separated portions to form first and second longitudinally extending, spaced drop warp portions with weft yarns passing through the drop warp portions to join respective completely woven portions on either side of the drop warp portions, the drop warp portions spaced apart by a sufficient distance to accommodate the core placed longitudinally in general alignment with the longitudinally extending drop warp portions such that the core is wrapped by a completely woven portion of the fabric strip, the strip wrapped about the core so that the first and second drop warp portions overlie each other;
means for securing together portions of the overlapped completely woven portions;
wherein the weft yarns in the overlying first and second drop warp portions are readily separated to push a fastener therethrough without mechanically cutting a fastener hole.

2. The gasket of claim 1, wherein the securing means comprises:
a first stitching seam extending longitudinally and sewing together overlapping completely woven portions of the fabric strip on a core side of the overlying first and second drop warp portions to define a gasket bulb with the core;
a second stitching seam extending longitudinally and sewing together overlapping completely woven portions of the fabric strip on a tail edge side of the overlying first and second drop warp portions.

3. The gasket of claim 1, wherein the fabric strip is a texturized fiberglass woven fabric.

4. The gasket of claim 1, wherein the core is a braided rope of texturized fiberglass.

5. The gasket of claim 1, wherein the fabric strip is a woven fabric with yarns selected from the group consisting of fiberglass, ceramic, carbon, graphite, aramid, polytetrafluoroethylene, with or without wire reinforcement.

6. A tadpole-type gasket, comprising:
a core;
a jacket wrapped about the core, comprising:
a woven fabric strip having a strip width, in which a plurality of warp threads are omitted from the strip in two separated portions to form first and second longitudinally extending, spaced drop warp portions with weft yarns passing through the drop warp portions to join respective completely woven portions on either side of the drop warp portions, the strip wrapped about the core so that the first and second drop warp portions overlie each other;
the drop warp portions spaced apart by a sufficient distance to accommodate the core placed longitudinally in general alignment with the longitudinally extending drop warp portions such that the core is wrapped by a completely woven portion of the fabric strip;
a first stitching seam extending longitudinally and sewing together overlapping completely woven portions of the fabric strip on a core side of the overlying first and second drop warp portions to define a gasket bulb with the core;
a second stitching seam extending longitudinally and sewing together overlapping completely woven portions of the fabric strip on a tail edge side of the overlying first and second drop warp portions;
wherein the weft yarns in the overlying first and second drop warp portions are readily separated to push a fastener therethrough without mechanically cutting a fastener hole.

7. The gasket of claim 6, wherein the fabric strip is a texturized fiberglass woven fabric.

8. The gasket of claim 6, wherein the core is a braided rope of texturized fiberglass.

9. The gasket of claim 6, wherein the fabric strip is a woven fabric with yarns selected from the group consisting of fiberglass, ceramic, carbon, graphite, aramid, polytetrafluoroethylene, with or without wire reinforcement.

10. A method of fabricating a tadpole-type gasket, comprising:
providing a woven fabric strip having a strip width, in which a plurality of warp threads are omitted from the strip in two separated portions to form first and second longitudinally extending, spaced drop warp portions with weft yarns passing through the drop warp portions to join respective completely woven portions on either side of the drop warp portions;
providing a gasket core;
wrapping the strip about the gasket core so that the first and second drop warp portions overlie each other, the drop warp portions spaced apart by a sufficient distance to accommodate the core placed longitudinally in general alignment with the longitudinally extending drop warp portions such that the core is wrapped by a completely woven portion of the fabric strip;
securing together portions of the overlapped completely woven portions;
wherein the weft yarns in the overlying first and second drop warp portions are readily separable to push a fastener therethrough without mechanically cutting a fastener hole.

11. The method of claim 10, wherein the fabric strip is a texturized fiberglass woven fabric.

12. The method of claim 10, wherein the core is a braided rope of texturized fiberglass.

13. The method of claim 10, wherein the fabric strip is a woven fabric with yarns selected from the group consisting of fiberglass, ceramic, carbon, graphite, aramid, polytetrafluoroethylene, with or without wire reinforcement.

14. The method of claim 10, wherein securing the overlying completely woven portions comprises:
sewing together overlying completely woven portions of the fabric strip on a core side of the overlying first and second drop warp portions to define a pocket surrounding the core;
sewing together overlapping completely woven portions of the fabric strip on a tail edge side of the overlying first and second drop warp portions.

15-19. (canceled)
